(19) United States
(12) Patent Application Publication
(10) Pub. No.: US 2020/0010113 A1
(43) Pub. Date: Jan. 9, 2020

(54) VEHICLE TRAVEL SUPPORT APPARATUS

(71) Applicant: TOYOTA JIDOSHA KABUSHIKI KAISHA, Toyota-shi (JP)

(72) Inventors: Yuji Watari, Toyota-shi (JP); Takafumi Tashiro, Toyota-shi (JP); Yoji Kunihiro, Susono-shi (JP); Takahiro Kojo, Gotemba-shi (JP); Ryo Irie, Okazaki-shi (JP); Yuichiro Ido, Miyoshi-shi (JP); Masaya Sato, Okazaki-shi (JP); Hisaya Akatsuka, Susono-shi (JP)

(73) Assignee: TOYOTA JIDOSHA KABUSHIKI KAISHA, Toyota-shi (JP)

(21) Appl. No.: 16/446,811

(22) Filed: Jun. 20, 2019

(30) Foreign Application Priority Data
Jul. 5, 2018 (JP) 2018-128228

(51) Int. Cl. B62D 6/00; B62D 5/04

(52) U.S. Cl. CPC B62D 6/00; B60W 30/12; B62D 5/0463

(57) ABSTRACT

Provided is a vehicle travel support apparatus including: a normal control module configured to execute travel support control; a correction control module configured to execute correction control in addition to the travel support control when a state of the vehicle is brought into an abnormal state during the execution of the travel support control; and a compensation control module configured to, when a finish condition is satisfied during the execution of the correction control, stop both the travel support control and the correction control and execute compensation control.

### CLAIM OF PRIORITY

The present application claims priority from Japanese patent application JP 2018-128228 filed on Jul. 5, 2018, the content of which is hereby incorporated by reference into this application.

### BACKGROUND

### 1. Technical Field

The present disclosure relates to a vehicle travel support apparatus configured to support traveling of a vehicle.

### 2. Description of the Related Art

Hitherto, there has been known a control apparatus configured to acquire vehicle peripheral information on a peripheral state (such as partition lines and other vehicles) of a vehicle, and automatically control steering of the vehicle so that the vehicle travels along a target travel line set based on the vehicle peripheral information. Such control is one type of travel support control, and is also referred to as “lane trace control”.

Meanwhile, one of related-art apparatus, which is configured to execute such travel support control (hereinafter referred to as “related-art apparatus”), executes abnormal-time travel control when an abnormality has occurred in a steering system during the execution of the travel support control (see, for example, Japanese Patent Application Laid-open No. 2016-094038). Specifically, the related-art apparatus executes control of a braking force for applying a yaw moment to a vehicle as the abnormal-time travel control when an abnormality has occurred in the steering system.

Incidentally, a travel direction of the vehicle deviates toward any one of the left side and the right side not only in the case in which an abnormality has occurred in the steering system but also in a case in which a difference between left and right tire pressures increases and a case in which a wheel alignment changes, for example. When such a state has occurred during the execution of the travel support control, a “possibility that the travel support control enables the vehicle to travel along the target travel line” decreases. Therefore, an apparatus (vehicle travel support apparatus) configured to execute the vehicle travel support control executes correction control of correcting the deviation of the travel direction of the vehicle when such an abnormal state has occurred during the execution of the travel support control.

For example, an apparatus, which is configured to execute the travel support control by matching an actual steering torque with a target steering torque, executes control of driving a steering actuator so that the actual steering torque matches a “steering torque obtained by correcting the target steering torque through use of a predetermined compensation control amount” as the correction control when an abnormal state has occurred. The correction control may be control of generating a yaw motion in the vehicle as the above-mentioned abnormal-time travel control.

Further, even in a case in which the correction control is executed, for example, when a distance between the vehicle and the target travel line gradually increases, it is conceivable to stop the travel support control, and cause a driver to take over the steering of the vehicle.

In this case, the vehicle is in the state of being greatly deviated, and hence, when the correction control is stopped simultaneously with the stop of the travel support control, there arises a problem in that the driver bears a larger load of the steering operation. Meanwhile, when control equivalent to the correction control is continued after the stop of the travel support control (that is, for example, when the steering actuator is driven so that the actual steering torque matches a “steering torque corresponding to the compensation control amount”), a turn characteristic of the vehicle in response to the steering operation is less likely to increase compared with the state before the occurrence of the abnormal state. In this case, although the driver bears a smaller load of the steering operation, the driver is less likely to feel a sense of discomfort when performing a steering operation, and hence there is a problem in that the driver hardly recognizes the occurrence of the abnormality in the vehicle.

### SUMMARY

The present disclosure provides a vehicle travel support apparatus capable of reducing an operation load on a driver when an abnormality has occurred during execution of travel support control (automatic driving control) and the travel support control is consequently switched to a manual operation by the driver, and enabling the driver to recognize that the abnormality has occurred during the travel support control.

A vehicle travel support apparatus according to one embodiment (hereinafter sometimes referred to as “apparatus of one embodiment”) includes a normal control module (10b) configured to execute travel support control of changing a turn control amount, which enables a travel direction of a vehicle to be changed, based on information on a road on which the vehicle is traveling so that the vehicle is to travel along the road.

The vehicle travel support apparatus further includes a correction control module (10c) configured to: determine whether a state of the vehicle is brought into an abnormal state, in which a possibility that the travel support control enables the vehicle to travel along the road is low, during the execution of the travel support control; and execute, when determining that the state of the vehicle is brought into the abnormal state, in addition to the travel support control, correction control of changing a first value (Trc, Mrc, Yrb) of a compensation control amount in accordance with a parameter indicating a travel state of the vehicle, the first value of the compensation control amount being a value which enables the travel direction of the vehicle to be changed and increases the possibility.

The vehicle travel support apparatus further includes a compensation control module (10d) configured to: determine whether a predetermined finish condition is satisfied during the execution of the correction control; and stop, when determining that the predetermined finish condition is satisfied, both the travel support control and the correction control and execute compensation control after a time point at which the predetermined finish condition is satisfied, the compensation control involving changing a second value (Trc′, Mrc′, Yrb′) of the compensation control amount in accordance with the parameter indicating the travel state of the vehicle, and the second value of the compensation control amount being a value which enables the travel direction of the vehicle to be changed and facilitates traveling of the vehicle along the road when a driver of the vehicle performs a steering operation so that the vehicle is to travel along the road.

The compensation control module is further configured to change the second value of the compensation control amount so that the second value has a value for generating, in the vehicle, a turn motion in the same direction as a direction of a turn motion generated in the vehicle by the first value of the compensation control amount determined by the correction control module on an assumption that the correction control is continued after the time point at which the predetermined finish condition is satisfied, and so that a magnitude of the second value is smaller than a magnitude of the first value.

The apparatus of one embodiment is configured to execute the compensation control based on the second value of the compensation control amount after the time point at which the travel support control is finished. Thus, when the driver of the vehicle performs a steering operation so that the vehicle is to travel along the road, the operation load (load required for the steering) on the driver can be reduced by an amount corresponding to the second value of the compensation control amount.

Further, according to the apparatus of one embodiment, after the time point at which the finish condition is satisfied (namely, the time point at which the travel support control is finished), the second value of the compensation control amount in the compensation control is set to a value which causes the vehicle to generate the turn motion in the same direction as the direction of the turn motion generated in the vehicle by the first value of the compensation control amount determined by the correction control module on the assumption that the correction control is continued after the time point at which the finish condition is satisfied, and whose magnitude is smaller than the magnitude of the first value. For example, at a certain specific time point after the travel support control is finished, the driver tiles to operate a steering wheel by a “steering amount considered to be required from experience (hereinafter referred to as “steering amount based on experience”)” on the basis of a travel state (a curvature of the road, a vehicle speed, and the like) at that specific time point. However, the magnitude of the second value of the compensation control amount in the compensation control after the travel support control is finished is smaller than the magnitude of the first value of the compensation control amount determined on the assumption that the correction control is executed at that specific time point. Thus, the driver is required to operate the steering wheel by a steering amount larger than the “steering amount based on experience”. As a result, the driver feels a sense of discomfort. In this manner, the apparatus of one embodiment can enable the driver to recognize occurrence of an abnormality in the own vehicle.

In one aspect of the apparatus of one embodiment, the normal control module is configured to use a control amount corresponding to a steering torque of the vehicle as the turn control amount, the correction control module is configured to use a control amount corresponding to a steering torque for correcting the turn control amount as the compensation control amount, and the compensation control module is configured to use a control amount corresponding to the steering torque of the vehicle as the compensation control amount.

The vehicle travel support apparatus in this aspect can use the control amount corresponding to the steering torque of the vehicle to execute the travel support control, the correction control, and the compensation control.

In one aspect of the apparatus of one embodiment, the normal control module is configured to determine a target travel line (TL) based on at least the information on the road, and change the turn control amount so that the vehicle is to travel along the target travel line, and the correction control module is configured to determine that the state of the vehicle is brought into the abnormal state when a state in which a magnitude of a distance between the vehicle and the target travel line is equal to or larger than a first threshold value (Th1) has continued for a first period threshold value (Tm1) or longer (Step 1020: Yes).

For example, an abnormality, such as an increase in the difference between left and right tire pressures or a change in the wheel alignment, may occur during traveling of the vehicle. In this case, a position of the vehicle in a road width direction is highly likely to deviate toward any one of the left side and the right side with respect to the target travel line. The vehicle travel support apparatus in this aspect can determine whether the above-mentioned abnormality has occurred based on the magnitude of the distance between the vehicle and the target travel line for the travel support control.

In one aspect of the apparatus of one embodiment, the compensation control module is configured to determine that the predetermined finish condition is satisfied when a state in which the magnitude of the distance between the vehicle and the target travel line is not equal to or smaller than a second threshold value (Th2), which is smaller than the first threshold value, has continued since a start time point of the correction control for a second period threshold value (Tm2) or longer (Step 1035: Yes).

The vehicle may deviate toward any one of the left side and the right side with respect to the target travel line due to, for example, a temporary side wind and/or a temporary change in a road surface state of a road. Such an abnormality is a temporary abnormality, and is highly likely to be solved after a certain period elapses. The vehicle travel support apparatus in this aspect is configured to determine that the finish condition is satisfied only when the state in which the magnitude of the distance between the vehicle and the target travel line is not equal to or smaller than the second threshold value, which is smaller than the first threshold value, has continued for the second period threshold value or longer. Thus, when the abnormal state of the vehicle is temporary, the vehicle travel support apparatus in this aspect can continuously execute the travel support control and the correction control.

In one aspect of the apparatus of one embodiment, the correction control module is configured to use the distance between the vehicle and the target travel line as the parameter indicating the travel state, and the compensation control module is configured to employ a product of the first value of the compensation control amount calculated by the correction control module and a positive gain smaller than 1, as the second value of the compensation control amount.

The vehicle travel support apparatus in this aspect can, after the time point at which the finish condition is satisfied, multiply the first value of the compensation control amount in the correction control by the gain to calculate the second value of the compensation control amount, to thereby execute the compensation control.

In the above description, in order to facilitate understanding of the present disclosure, names and/or reference symbols used in an embodiment of the present disclosure described later are enclosed in parentheses and are assigned to each of the constituent features corresponding to the embodiment. However, each of the constituent features is not limited to the embodiment defined by the names and/or reference symbols.

### BRIEF DESCRIPTION OF THE DRAWINGS

FIG. 1 is a schematic configuration diagram for illustrating a vehicle travel support apparatus according to an embodiment.

FIG. 2 is a plan view for illustrating lane trace control using a target travel line determined based on a center line of a travel lane.

FIG. 3 is a plan view for illustrating the lane trace control using a target travel line determined based on a preceding-vehicle trajectory.

FIG. 4 is a diagram for illustrating processing of correcting the preceding-vehicle trajectory of a preceding vehicle based on the center line of the travel lane.

FIG. 5 is a plan view for illustrating correction control by the vehicle travel support apparatus according to the embodiment.

FIG. 6 is a plan view for illustrating a state in which the vehicle is deviated toward a right side with respect to the target travel line.

FIG. 7 is a graph for showing an operation of a travel support ECU in the embodiment under the state of FIG. 6.

FIG. 8 is a flowchart for illustrating an “LTC start/finish determination routine” to be executed by the travel support ECU in the embodiment.

FIG. 9 is a flowchart for illustrating an “LTC execution routine” to be executed by the travel support ECU in the embodiment.

FIG. 10 is a flowchart for illustrating a “correction control start/finish determination routine” to be executed by the travel support ECU in the embodiment.

FIG. 11 is a flowchart for illustrating a “compensation control execution routine” to be executed by the travel support ECU in the embodiment.

### DESCRIPTION OF THE EMBODIMENTS

Now, referring to the accompanying drawings, a description is given of an embodiment of the present disclosure. The accompanying drawings are illustrations of a specific embodiment, but those illustrations are examples to be used for the understanding of the present disclosure, and are not to be used to limit the interpretation of the present disclosure.

<Configuration>

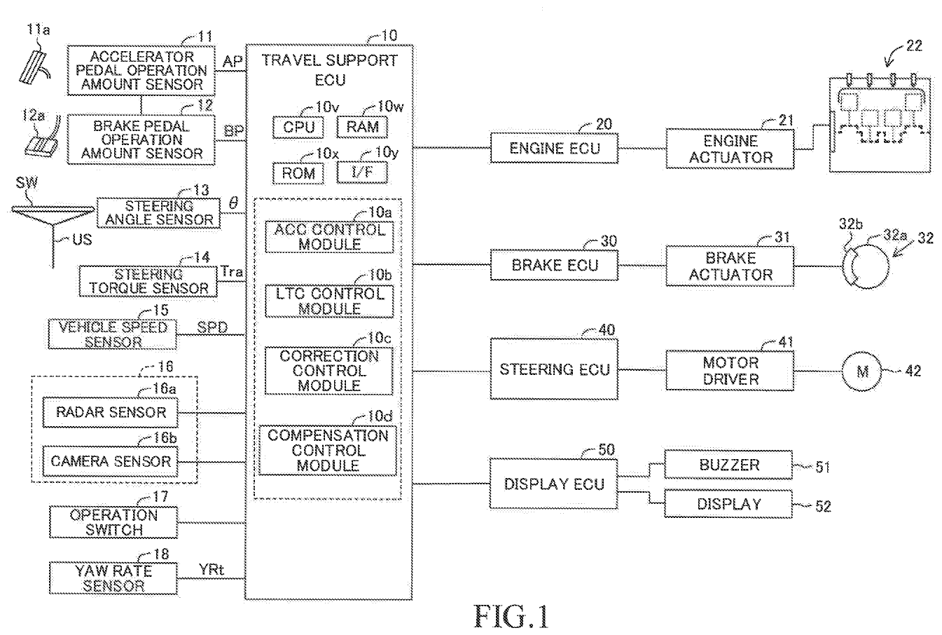

A vehicle travel support apparatus according to the embodiment (hereinafter sometimes referred to as “apparatus of this embodiment”) is applied to a vehicle (motor vehicle). The vehicle to which the apparatus of this embodiment is applied is sometimes referred to as “own vehicle” so as to be distinguished from other vehicles. As illustrated in FIG. 1, the apparatus of this embodiment includes a travel support ECU 10, an engine ECU 20, a brake ECU 30, a steering ECU 40, and a display ECU 50.

Those ECUs are electric control units each including a microcomputer as a main part, and are connected to one another so as to be able to mutually transmit and receive information via a controller area network (CAN) (not shown). The microcomputer herein includes a CPU, a RAM, a ROM, an interface I/F and the like. For example, the travel support ECU 10 includes a microcomputer including a CPU 10v, a RAM 10w, a ROM 10x, an interface (I/F) 10y, and the like. The CPU 10v is configured to execute instructions (programs and routines) stored in the ROM 10x to implement various functions.

The travel support ECU 10 is connected to sensors (including switches) listed below, and is configured to receive detection signals or output signals from those sensors. Alternatively, each sensor may be connected to an ECU other than the travel support ECU 10. In this case, the travel support ECU 10 receives the detection signal or the output signal of the sensor from the ECU to which the sensor is connected via the CAN.

An accelerator pedal operation amount sensor 11 is configured to detect an operation amount (accelerator opening degree) AP of an accelerator pedal 11a of the own vehicle, and output a signal representing the accelerator pedal operation amount AP.

A brake pedal operation amount sensor 12 is configured to detect an operation amount BP of a brake pedal 12a of the own vehicle, and output a signal representing the brake pedal operation amount BP.

A steering angle sensor 13 is configured to detect a steering angle θ of the own vehicle, and output a signal representing the steering angle θ. The steering angle θ has a positive value when a steering wheel SW is rotated toward a first direction (left direction) from a predetermined reference position (namely, a neutral position), and has a negative value when the steering wheel SW is rotated toward a second direction (right direction) opposite to the first direction from the predetermined reference position.

A steering torque sensor 14 is configured to detect a steering torque Tra applied to a steering shaft US of the own vehicle by the steering of a steering wheel SW, and output a signal representing the steering torque Tra. The steering torque Tra has a positive value when the steering torque Tra is a torque for rotating the steering wheel SW toward the first direction (left direction), and has a negative value when the steering torque Tra is a torque for rotating the steering wheel SW toward the second direction (right direction).

A vehicle speed sensor 15 is configured to detect a travel speed (vehicle speed) SPD of the own vehicle, and output a signal representing the vehicle speed SPD.

An ambient sensor 16 is configured to acquire at least information on a road ahead of the own vehicle, and three-dimensional (3D) objects existing on the road. The 3D object means a moving object (for example, a pedestrian, a bicycle, or a motor vehicle), or a fixed object (for example, an electric pole, a tree, or a guard rail). Those 3D objects are hereinafter simply referred to as “objects”. The ambient sensor 16 includes a radar sensor 16a and a camera sensor 16b.

The radar sensor 16a is configured to radiate, for example, a radio wave in a millimeter wave band (hereinafter referred to as “millimeter wave”) to a peripheral region of the own vehicle including at least a region ahead of the own vehicle, and receive a millimeter wave (namely, a reflected wave) reflected by an object existing in the radiation range. Further, the radar sensor 16a is configured to determine whether or not an object exists, and calculate and output parameters (namely, a position of the object with respect to the own vehicle, a distance between the own vehicle and the object, a relative speed between the own vehicle and the object, and other such parameters) indicating a relative relationship between the own vehicle and the object.

More specifically, the radar sensor 16a includes a millimeter wave transmission/reception module and a processing module. The processing module obtains, each time a predetermined period elapses, the parameters indicating the relative relationship between the own vehicle and the object based on a phase difference between the millimeter wave transmitted from the millimeter wave transmission/reception module and a reflected wave received by the millimeter wave transmission/reception module, an attenuation level of the reflected wave, a period from the transmission of the millimeter wave to the reception of the reflected wave, and other such information. Those parameters contain an inter-vehicle distance (longitudinal distance) Dfx(n), a relative speed Vfx(n), a lateral distance Dfy(n), and a relative lateral speed Vfy(n) with respect to each detected object(n).

The inter-vehicle distance Dfx(n) is a distance between the own vehicle and the object(n) (e.g., a preceding vehicle) along a center axis of the own vehicle (an axis passing through a center of the own vehicle in a widthwise direction thereof, and extending in a front/rear direction of the own vehicle, namely, an x axis described later).

The relative speed Vfx(n) is a difference (=Vs−Vj) between a speed Vs of the object(n) (e.g., a preceding vehicle) and a speed Vj of the own vehicle. The speed Vs of the object(n) is a speed of the object(n) in a travel direction of the own vehicle (namely, the direction of the x axis described later).

The lateral distance Dfy(n) is a distance of a “center position of the object(n) (e.g., a center position of a vehicle width of a preceding vehicle)” from the center axis of the own vehicle in a direction orthogonal to the center axis of the own vehicle (namely, a direction of a y axis described later). The lateral distance Dfy(n) is also referred to as “lateral position”.

The relative lateral speed Vfy(n) is a speed of the center position of the object(n) (e.g., the center position of the vehicle width of a preceding vehicle) in the direction orthogonal to the center axis of the own vehicle (namely, the direction of the y axis described later).

The camera sensor 16b includes a stereo camera and an image processor, and takes images of scenes in a left-side region and a right-side region forward of the vehicle to acquire a pair of left and right pieces of image data. The camera sensor 16b is configured to determine whether or not an object exists based on the pair of left and right pieces of taken image data, calculate parameters indicating the relative relationship between the own vehicle and the object, and output a determination result and a calculation result. In this case, the travel support ECU 10 is configured to combine parameters indicating the relative relationship between the own vehicle and the object obtained by the radar sensor 16a and parameters indicating the relative relationship between the own vehicle and the object obtained by the camera sensor 16b with each other, to thereby determine the parameters indicating the relative relationship between the own vehicle and the object.

Further, the camera sensor 16b recognizes left and right partition lines of the road (travel lane in which the own vehicle is traveling) based on the pair of left and right pieces of taken image data, and calculates shapes of the road (e.g., a curvature of the road) and parameters indicating a positional relationship between the road and the own vehicle. The parameters indicating the positional relationship between the road and the own vehicle include, for example, a distance from a left end or a right end of the lane in which the own vehicle is traveling to the center position of the own vehicle in the vehicle widthwise direction. This distance is referred to as “own vehicle lateral position”. Information on the lane including the shapes of the road and the positional relationship between the road and the own vehicle is referred to as “lane information”. The partition lines include, for example, a white line and a yellow line, but the following description is given based on the assumption that the partition line is a white line.

Information on an object (including parameters indicating the relative relationship between the own vehicle and the object) acquired by the ambient sensor 16 is referred to as “object information”. The ambient sensor 16 transmits the object information and the lane information to the travel support ECU 10 each time a predetermined sampling period elapses. The ambient sensor 16 is not always required to include both the radar sensor and the camera sensor, and may include, for example, only the camera sensor.

An operation switch 17 is a switch to be operated by the driver. The driver can operate the operation switch 17 to select whether or not to execute adaptive cruise control described later. Further, the driver can operate the operation switch 17 to select whether or not to execute lane trace control described later.

A yaw rate sensor 18 is configured to detect a yaw rate of the own vehicle, and output an actual yaw rate YRt. The yaw rate is zero when a change amount per unit time of the yaw angle of the own vehicle is zero, is a positive value when the yaw angle of the own vehicle changes toward a left turn direction, and is a negative value when the yaw angle of the own vehicle changes toward a right turn direction,

The engine ECU 20 is connected to an engine actuator 21. The engine actuator 21 includes a throttle valve actuator configured to change an opening degree of a throttle valve of an internal combustion engine 22. The engine ECU 20 can drive the engine actuator 21 to change a torque generated by the internal combustion engine 22. The torque generated by the internal combustion engine 22 is transmitted to drive wheels (not shown) via a transmission (not shown). Thus, the engine ECU 20 can control the engine actuator 21 to control a driving force of the own vehicle, to thereby change an acceleration state (acceleration). When the own vehicle is a hybrid vehicle, the engine ECU 20 can control a driving force of the own vehicle generated by any one of or both of an “internal combustion engine and electric motor” serving as vehicle driving sources. When the own vehicle is an electric vehicle, the engine ECU 20 can control a driving force of the own vehicle generated by an electric motor serving as a vehicle driving source.

The brake ECU 30 is connected to a brake actuator 31. The brake actuator 31 is provided in a hydraulic circuit between a master cylinder (not shown) configured to pressurize a working fluid with a stepping force on a brake pedal 12a and friction brake mechanisms 32 provided on the front/rear left/right wheels. The brake actuator 31 adjusts a hydraulic pressure of the working fluid to be supplied to a wheel cylinder integrated into the brake caliper 32b of the friction brake mechanism 32 in accordance with an instruction from the brake ECU 30. With the wheel cylinder being operated by the hydraulic pressure, a brake pad is pressed against a brake disc 32a to generate a friction braking force. Thus, the brake ECU 30 can control the brake actuator 31 to control the braking force of the own vehicle and change an acceleration state (a deceleration, namely, a negative acceleration) of the own vehicle.

The steering ECU 40 is a control device for a known electric power steering system, and is connected to a motor driver 41. The motor driver 41 is connected to a steering motor 42. The steering motor 42 is integrated into a “steering mechanism (not shown) including the steering wheel SW, the steering shaft US coupled to the steering wheel SW, a steering gear mechanism, and the like” of the vehicle. The steering wheel motor 42 can use electric power supplied from an in-vehicle battery (not shown) via the motor driver 41 to generate a torque, use this torque to generate a steering assist torque, and steer left and right steered wheels. That is, the steering motor 42 can change a steering angle of the own vehicle.

The display ECU 50 is connected to a buzzer 51 and a display 52. The display ECU 50 can sound the buzzer 51 to attract attention of the driver in response to an instruction from the travel support ECU 10. Further, the display ECU 50 can turn on a mark (e.g., a warning lamp) for attracting the attention, display an alarm image, display a warning message, and display an operation state of the travel support control, on the display 52 in response to an instruction from the travel support ECU 10. The display 52 is a head-up display, but may be a display of another type.

A description is now given of an overview of an operation of the travel support ECU 10. The travel support ECU 10 can execute the “adaptive cruise control” and the “lane trace control”.

<Adaptive Cruise Control (ACC)>

The adaptive cruise control is control of causing the own vehicle to follow a preceding vehicle (ACC following target vehicle described later) traveling immediately ahead of the own vehicle in a region ahead of the own vehicle while maintaining a distance between the own vehicle and the preceding vehicle to be a predetermined distance based on the object information. The ACC itself is widely known (see, for example, Japanese Patent Application Laid-open No. 2014-148293, Japanese Patent Application Laid-open No. 2006-315491, Japanese Patent No. 4172434, and Japanese Patent No. 4929777). Thus, a brief description is now given of the ACC.

The travel support ECU 10 executes the adaptive cruise control when the adaptive cruise control is requested by the operation on the operation switch 17.

More specifically, when the adaptive cruise control is requested, the travel support ECU 10 selects an ACC following target vehicle based on the object information acquired by the ambient sensor 16. For example, the travel support ECU 10 determines whether or not a relative position of a detected object (n) identified by the lateral distance Dfy(n) and the inter-vehicle distance Dfx(n) of the object (n) exists in a following-target-vehicle area. The following-target-vehicle area is an area defined in advance so that an absolute value of a distance in a lateral direction with respect to the travel direction of the own vehicle, which is estimated based on the vehicle speed of the own vehicle and the yaw rate of the own vehicle, decreases as a distance in the travel direction increases. Then, the travel support ECU 10 selects the object(n) as the ACC following target vehicle when the relative position of the object(n) exists in the following-target-vehicle area for a predetermined period or longer. When there are a plurality of objects for which the relative position exists in the following-target-vehicle area for the predetermined period or longer, the travel support ECU 10 selects an object having the shortest inter-vehicle distance Dfx(n) from among those objects as the ACC following target vehicle.

Further, the travel support ECU 10 calculates a target acceleration Gtgt in accordance with any one of Expression (1) and Expression (2) given below. In Expression (1) and Expression (2), Vfx(a) represents a relative speed of an ACC following target vehicle (a), k1 and k2 represent predetermined positive gains (coefficients), and ΔD1 represents an inter-vehicle distance difference (=Dfx(a)−Dtgt) obtained by subtracting a “target inter-vehicle distance Dtgt” from an “inter-vehicle distance Dfx(a) of the ACC following target vehicle (a)”. The target inter-vehicle distance Dtgt is calculated by multiplying a target inter-vehicle period Ttgt set by the driver using the operation switch 17 by the vehicle speed SPD of the own vehicle 100 (that is, Dtgt=Ttgt·SPD),

The travel support ECU 10 uses Expression (1) given below to determine the target acceleration Gtgt when the value (k1·ΔD1+k2·Vfx(a)) is positive or “0”. ka1 represents a positive gain (coefficient) for acceleration, and is set to a value equal to or smaller than “1”.

The travel support ECU 10 uses Expression (2) given below to determine the target acceleration Gtgt when the value (k1·ΔD1+k2·Vfx(a)) is negative, kd1 represents a positive gain (coefficient) for deceleration, and is set to “1” in this example.

Gtgt(for acceleration)=ka1·(k1·ΔD1+k2·Vfx(a)) (1)

Gtgt(for deceleration)=kd1·(k1·ΔD1+k2·Vfx(a)) (2)

When an object does not exist in the following target vehicle area, the travel support ECU 10 determines the target acceleration Gtgt based on a “target speed set in accordance with the target inter-vehicle distance Ttgt” and the “vehicle speed SPD of the own vehicle” so that the vehicle speed SPD matches the target speed.

The travel support ECU 10 uses the engine ECU 20 to control the engine actuator 21, and, as required, uses the brake ECU 30 to control the brake actuator 31 so that the acceleration of the vehicle matches the target acceleration Gtgt. As described above, the travel support ECU 10 functionally includes an “ACC control module (adaptive cruise control unit) 10a configured to execute the adaptive cruise control (ACC)”, which is implemented by the CPU.

<Lane Trace Control (LTC)>

The travel support ECU 10 executes the lane trace control when the lane trace control is requested by an operation on the operation switch 17 during the execution of the adaptive cruise control.

In the lane trace control, the travel support ECU 10 determines (sets) a target travel line (target travel path) by using any one of or both of the white lines and a travel trajectory (namely, preceding-vehicle trajectory) of the preceding vehicle. The travel support ECU 10 applies a steering torque to the steering mechanism to change the steering angle of the own vehicle so that the lateral position of the own vehicle is maintained in a vicinity of the target travel line, to thereby support the steering operation by the driver (see, for example, Japanese Patent Application Laid-open No. 2008-195402, Japanese Patent Application Laid-open No. 2009-190464, Japanese Patent Application Laid-open No. 2010-6279, and Japanese Patent No. 4349210). Such lane trace control is also sometimes referred to as “traffic jam assist (TJA)”.

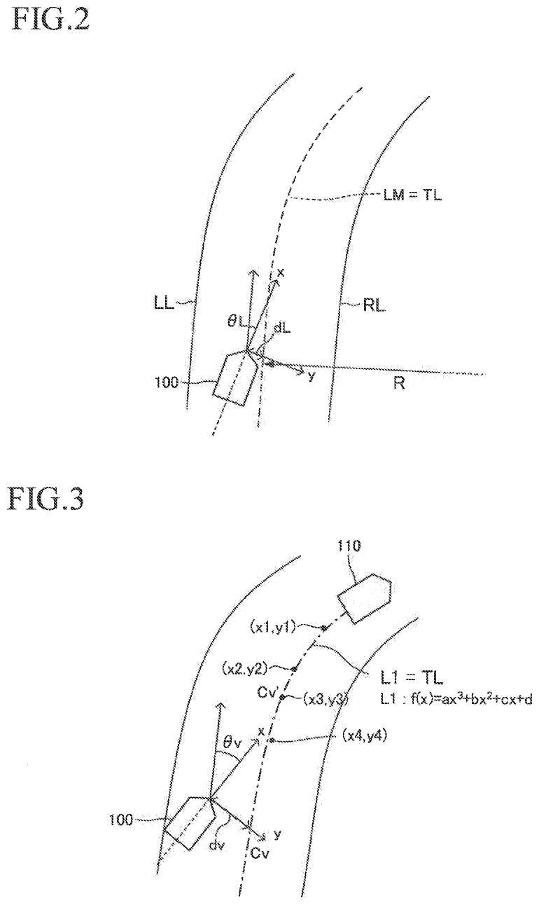

A description is now given of the lane trace control using the target travel line determined based on the white lines. As illustrated in FIG. 2, the travel support ECU 10 acquires information on a “left white line LL and right white line RL” defining the travel lane, which is a lane in which the own vehicle 100 is traveling, based on the lane information transmitted from the ambient sensor 16. The travel support ECU 10 estimates, as a “center line LM of the travel lane”, a line connecting center positions between the acquired left white line LL and right white line RL in a road widthwise direction to one another.

Further, the travel support ECU 10 calculates a curve radius R and a curvature CL (=1/R) of the center line LM of the travel lane, and also calculates a position and a direction of the own vehicle 100 in the travel lane defined/partitioned by the left white line LL and the right white line RL. More specifically, as illustrated in FIG. 2, the travel support ECU 10 calculates a distance dL in a y-axis direction (substantially the road widthwise direction) between the center position of the own vehicle 100 in the vehicle widthwise direction and the center line LM of the travel lane, and calculates a deviation angle θL (yaw angle θL) between a direction (a tangent direction) of the center line LM and the travel direction of the own vehicle 100. Those parameters are target travel path information (the curvature CL of a target travel line TL, the yaw angle θL with respect to the target travel line IL, and the distance dL to the target travel line TL in the road widthwise direction) required for the lane trace control when the center line LM of the travel lane is set as the target travel line TL. x-y coordinates illustrated in FIG. 2 are coordinates obtained when the center axis extending in the front/rear direction of the own vehicle 100 is set as an x axis, the axis orthogonal to the x axis is set as a y axis, and a current position of the own vehicle 100 is set as an origin (x=0 and y=0).

The travel support ECU 10 calculates a target yaw rate YRc* by assigning the curvature CL, the vehicle speed SPD, the yaw angle θL, and the distance dL to Expression (3) each time a predetermined period elapses when executing the lane trace control. In Expression (3), K1, K2, and K3 represent control gains.

YRc*=K1×dL+K2×θL+K3×CL×SPD (3)

Further, the travel support ECU 10 obtains a target steering torque Tr* for achieving the target yaw rate YRc* by applying the target yaw rate YRc*, the actual yaw rate YRt, and the vehicle speed SPD to a lookup table Map (Yrc*, YRt, SPD) (that is, Tr*=Map (Yrc*, YRt, SPD)). Then, the travel support ECU 10 uses the steering ECU 40 to control the steering motor 42 so that the actual steering torque Tra matches the target steering torque Tr*. The lookup table MAP (YRc*, YRt, SPD) is stored in the ROM 10x.

The “target steering torque Tr*” is a control amount enabling the travel direction of the own vehicle to be changed (that is, a control amount enabling the steering angle of the own vehicle to be changed), and is sometimes referred to as “turn control amount” for the sake of convenience. This concludes the description of the overview of the lane trace control using the target travel line determined based on the white lines.

A description is now given of the lane trace control using the target travel line determined based on the preceding-vehicle trajectory. Such lane trace control is also referred to as “following steering control”. The preceding vehicle for which the preceding-vehicle trajectory is used to determine the target travel line is also referred to as “steering-following preceding vehicle”. The travel support ECU 10 identifies the preceding vehicle (namely, the steering-following preceding vehicle), which is an object for which the preceding-vehicle trajectory for determining the target travel line is to be generated, as in the case of the ACC following target vehicle.

As illustrated in FIG. 3, the travel support ECU 10 identifies a preceding vehicle 110, which is an object for which a preceding-vehicle trajectory L1 is to be generated, and generates the preceding-vehicle trajectory L1 based on object information containing position information on the preceding vehicle 110 with respect to the position of the own vehicle 100 for each predetermined period. For example, the travel support ECU 10 converts the position information on the preceding vehicle 110 to position coordinate data represented in the above-mentioned x-y coordinate system. For example, (x1, yl), (x2, y2), (x3, y3), and (x4, y4) of FIG. 3 are examples of the position coordinate data on the preceding vehicle 110 converted in such a manner. The travel support ECU 10 generates the preceding-vehicle trajectory L1 of the preceding vehicle 110 through application of curve fitting processing to the position coordinate data. A curve to be used for the fitting processing is a cubic function f(x). The fitting processing is executed through use of, for example, the least squares method.

The travel support ECU 10 calculates target travel path information (dv, θy, Cv, and Cv′ described below) required for the lane trace control when the preceding-vehicle trajectory L1 is set as the target travel line TL, based on the preceding-vehicle trajectory L1 of the preceding vehicle 110 and the position and the direction of the own vehicle 100.

dv: A distance in the y-axis direction (substantially the road widthwise direction) between the center position of the own vehicle 100 at the current position (x=0 and y=0) in the vehicle widthwise direction and the preceding-vehicle trajectory

θv: A deviation angle (yaw angle) between the direction (tangent direction) of the preceding-vehicle trajectory L1 corresponding to the current position (x=0 and y=0) of the own vehicle 100 and the travel direction (the +direction of the x axis) of the own vehicle 100.

Cv: A curvature of the preceding-vehicle trajectory L1 at a position (x=0 and y=dv) corresponding to the current position (x=0 and y=0) of the own vehicle 100.

Cy′: A curvature change rate (a curvature change amount per unit distance (Δx) at any position (x=x0; x0 is any value) of the preceding-vehicle trajectory L1).

Then, the travel support ECU 10 calculates the target yaw rate YRc* by replacing dL by dv, replacing θL by θv, and replacing CL by Cv in Expression (3). Further, the travel support ECU 10 uses the lookup table Map (YRc*, YRt, SPD) to calculate the target steering torque Tr* for achieving the target yaw rate YRc*. Then, the travel support ECU 10 uses the steering ECU 40 to control the steering motor 42 so that the actual steering torque Tra matches the target steering torque Tr*.

This concludes the description of the overview of the lane trace control using the target travel line determined based on the preceding-vehicle trajectory.

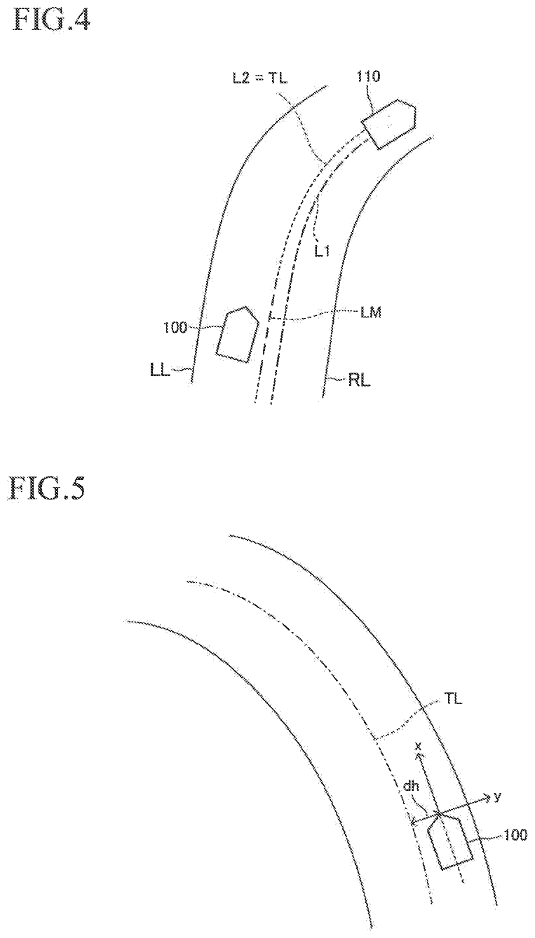

The travel support ECU 10 may be configured to generate the target travel line TL through use of a combination of the preceding-vehicle trajectory L1 and the center line LM of the travel lane. More specifically, for example, as illustrated in FIG. 4, the travel support ECU 10 corrects the preceding-vehicle trajectory L1 so that the preceding-vehicle trajectory L1 becomes a “trajectory maintaining the shape (curvature) of the preceding-vehicle trajectory L1, and matching the position of the center line LM and the direction (tangent direction) of the center line LM in a vicinity of the own vehicle 100”. Then, the travel support ECU 10 may determine a “corrected preceding-vehicle trajectory L2” as the target travel line TL.

For example, in such a manner as described in the items (a) to (d) given below, the travel support ECU 10 sets the target travel line TL in accordance with the presence/absence of the preceding vehicle and the recognition state of the white lines, to thereby execute the lane trace control.

(a) When the left and right white lines have been recognized up to a far position, the travel support ECU 10 sets the target travel line TL based on the center line LM of the travel lane, to thereby execute the lane trace control.

(b) When the steering-following preceding vehicle exists ahead of the own vehicle, and none of the left and right white lines has been recognized, the travel support ECU 10 sets the target travel line TL based on the preceding-vehicle trajectory L1 of the steering-following preceding vehicle, to thereby execute the lane trace control (following steering control).

(c) When the steering-following preceding vehicle exists ahead of the own vehicle, and the left and right white lines have been recognized in a vicinity of the own vehicle, the travel support ECU 10 sets, as the target travel line TL, the corrected preceding-vehicle trajectory L2 obtained by correcting the preceding-vehicle trajectory L1 of the steering-following preceding vehicle through use of the white lines, to thereby execute the lane trace control.

(d) When the steering-following preceding vehicle does not exist ahead of the own vehicle, and the white lines of the road have not been recognized up to a far position, the travel support ECU 10 cancels the lane trace control.

As described above, the travel support ECU 10 functionally includes an “LTC control module (a normal control module, a lane trace control module, and a travel support control module) 10b configured to execute the lane trace control of changing the steering angle of the own vehicle so that the own vehicle is to travel along the target travel one”, which is implemented by the CPU.

<Correction Control and Compensation Control>

The travel support ECU 10 executes correction control when an abnormality has occurred in the own vehicle during the execution of the lane trace control. Referring to FIG. 5, a description is now given of the correction control.

The travel support ECU 10 determines whether or not the own vehicle 100 is in a predetermined specific state during the execution of the lane trace control. In this example, the specific state is a state in which a magnitude (absolute value) |dh| of a distance dh in the y-axis direction between the center position of the own vehicle 100 in the vehicle widthwise direction and the target travel line TL is equal to or larger than a predetermined first threshold value Th1. The distance dh is also referred to as “lateral deviation”. The lateral deviation dh has a positive value when the own vehicle 100 is traveling at a position deviating toward the left side with respect to the target travel line TL, and has a negative value when the own vehicle 100 is traveling at a position deviating toward the right side with respect to the target travel line TL.

Further, the travel support ECU 10 determines whether or not a predetermined abnormality condition is satisfied during the execution of the lane trace control. The abnormality condition is a condition to be used to determine whether or not the “vehicle is in a state of being less likely to be able to travel along the target travel line TL through the lane trace control”. Specifically, the abnormality condition is satisfied when the above-mentioned specific state has continued for a predetermined first period threshold value Tm1 or longer. When the travel support ECU 10 determines that the abnormality condition is satisfied, the travel support ECU 10 determines that the vehicle is in the abnormal state.

When the travel support ECU 10 determines that the abnormality condition is satisfied (that is, determines that the own vehicle 100 is in the abnormal state), the travel support ECU 10 starts the execution of the correction control described below. That is, first, the travel support ECU 10 calculates a compensation steering control amount (namely, a compensation steering torque Trc) for correcting the basic steering control amount (namely, the target steering torque Tr*). Specifically, the travel support ECU 10 calculates the compensation steering torque Trc through application of the actual lateral deviation dh and the actual vehicle speed SPD to a lookup table MapTrc (dh, SPD) defining a relationship among the lateral deviation dh, the vehicle speed SPD, and the compensation steering torque Trc. The lookup table MapTrc (dh, SPD) is stored in the ROM 10x. The compensation steering torque Trc is a control amount “which enables the travel direction of the own vehicle 100 to be changed and increases a possibility that the own vehicle 100 is enabled to travel along the target travel lint TL”. The compensation steering torque Trc is sometimes referred to as “first value of the compensation control amount” for the sake of convenience.

With the table MapTrc (dh, SPD), when the lateral deviation dh is a positive value (that is, when the own vehicle 100 is traveling at a position deviating toward the left side with respect to the target travel line IL), the compensation steering torque Trc is set to a negative value. Meanwhile, when the lateral deviation dh is a negative value (that is, when the own vehicle 100 is traveling at a position deviating toward the right side with respect to the target travel line IL), the compensation steering torque Trc is set to a positive value.

Thus, when the travel support ECU 10 determines that the own vehicle 100 is in the abnormal state during the execution of the lane trace control, the travel support ECU 10 obtains, as the final steering control amount, a value (=Tr*+Trc) by adding the compensation steering control amount (compensation steering torque Trc) to the basing steering control amount (target steering torque Tr*). Then, the travel support ECU 10 controls the steering motor 42 so that the actual steering torque Tra matches the final steering control amount (=Tr*+Trc). This control is control referred to as “correction control”.

As described above, the travel support ECU 10 functionally includes a “correction control module 10c configured to execute the correction control in addition to the lane trace control when an abnormal state of the vehicle has occurred during the execution of the lane trace control”, which is implemented by the CPU.

Further, the travel support ECU 10 determines that a finish condition is satisfied when the lateral deviation dh has not fallen below a second threshold value Th2 by a time point when a second period threshold value Tm2 has elapsed since a time point (namely, a time point when the correction control was started) when the travel support ECU 10 determined that an abnormal state of the vehicle occurred during the execution of the lane trace control. The second threshold value Th2 is a value smaller than the first threshold value Th1, and is a threshold value to be used to determine whether or not the position of the own vehicle 100 has been returned to a vicinity of the target travel line TL. When the travel support ECU 10 determines that the finish condition is satisfied, the travel support ECU 10 quickly decreases the target steering torque Tr* to 0, to thereby finish the lane trace control.

Even after the time point at which the finish condition is satisfied, the travel support ECU 10 continues control based on a control amount (compensation steering control amount) corresponding to the steering torque of the vehicle. The control to be executed after the lane trace control is finished is referred to as “compensation control” for the sake of convenience. The travel support ECU 10 calculates a compensation steering torque Trc′ to be used for the compensation control as described below after the lane trace control is finished.

The compensation steering torque Trc′ has the same sign (positive or negative) as that of the compensation steering torque Trc calculated based on the travel state (lateral deviation dh and actual vehicle speed SPD) at a time point at which the lane trace control is finished. That is, the compensation steering torque Trc is a value for generating a turn motion in the same direction as that of a turn motion of the own vehicle corresponding to the compensation steering torque Trc calculated based on the travel state at the time point at which the lane trace control is finished. Thus, the compensation steering torque Trc′ is a control amount for “facilitating traveling of the own vehicle 100 along the road” when the driver performs a steering operation so that the vehicle is to travel along the road after the lane trace control is finished.

Further, a magnitude (absolute value) of the compensation steering torque Trc′ is smaller than a magnitude (absolute value) of the compensation steering torque Trc. More specifically, the travel support ECU 10 obtains the compensation steering torque Trc′ for the compensation control after the lane trace control is finished by multiplying the compensation steering torque Trc at the time point at which the lane trace control is finished by a “control gain Krc larger than 0 and smaller than 1”. The compensation steering torque Trc′ is sometimes referred to as “second value of the compensation control amount” for the sake of convenience.

The travel support ECU 10 determines the compensation steering torque Trc′ as the final steering control amount, and controls the steering motor 42 so that the actual steering torque Ira matches the final steering control amount (=Trc′). This control is control referred to as “compensation control”.

As described above, the travel support ECU 10 functionally includes a “compensation control module 10d configured to execute, when the lane trace control is finished under a state in which the correction control is executed, the compensation control after the lane trace control is finished”, which is implemented by the CPU.

<Details of Processing>

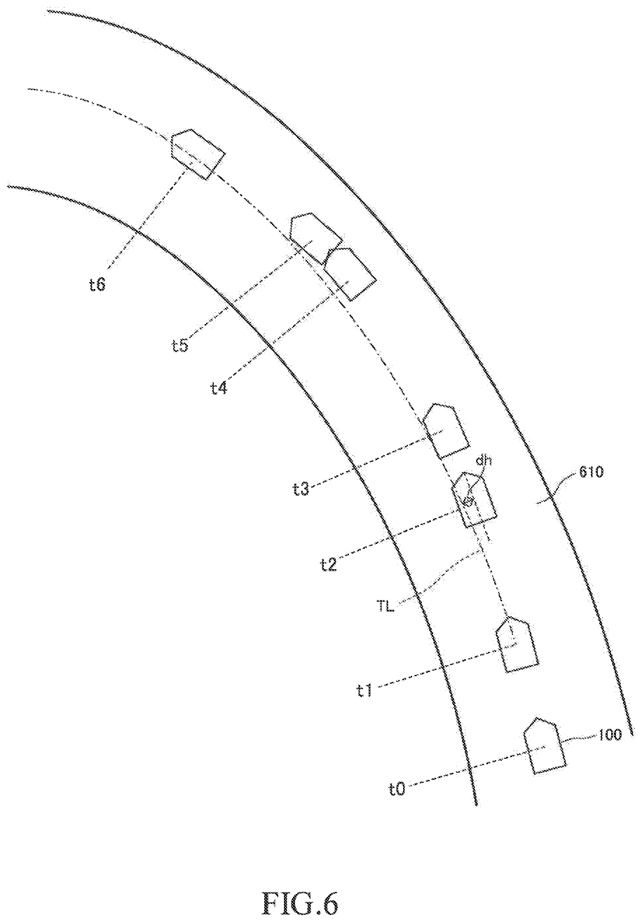

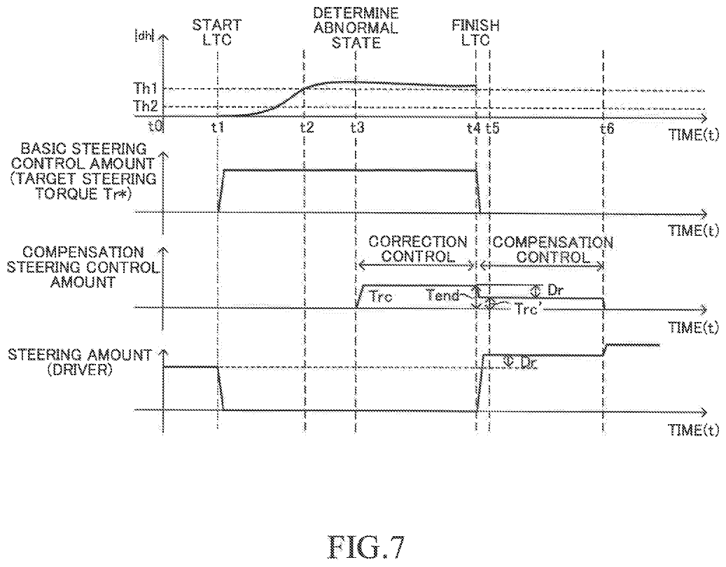

A description is now given of an example of an operation of the travel support ECU 10 illustrated in FIG. 6 and FIG. 7 to be executed when the own vehicle 100 deviates toward the right side with respect to the target travel line TL during the execution of the lane trace control. The vehicle 100 is executing the adaptive cruise control (ACC) before a time point t0. In FIG. 6, the ACC following target vehicle is omitted.

The vehicle 100 is traveling on a left curve 610 at the time point t0. At this time, the driver turns the steering wheel SW from the predetermined reference position toward the first direction (left direction). Thus, as shown in FIG. 7, a steering amount of the driver (the steering torque input by the driver) is a positive value at the time point t0.

At a time point t1, the driver operates the operation switch 17 to request execution of the lane trace control. Thus, the travel support ECU 10 sets the target travel line TL to start the lane trace control at the time point t1. The travel support ECU 10 calculates the steering control amount (target steering torque Tr*) based on the target travel line TL. In this case, the vehicle 100 is traveling on the left curve 610, and traveling close to the target travel line TL. Thus, as shown in FIG. 7, the target steering torque Tr* is a positive value. The travel support ECU 10 controls the steering motor 42 (that is, executes the lane trace control) so that the actual steering torque Tra matches the target steering torque Tr*. As a result of the start of the lane trace control, the steering amount of the driver becomes zero.

The travel support ECU 10 calculates the lateral deviation dh each time a predetermined period elapses after the time point t1. In the example illustrated in FIG. 6 and FIG. 7, at a time point t2, the magnitude (absolute value) |dh| of the lateral deviation dh becomes equal to or larger than the first threshold value Th1 (that is, the own vehicle 100 is brought into the specific state).

Then, at a time point t3, the above-mentioned specific state has continued for the predetermined first period threshold value Tm1 or longer, and thus the abnormality condition is satisfied. The travel support ECU 10 determines that the own vehicle 100 is in the abnormal state. Therefore, the travel support ECU 10 starts the correction control from the time point t3. The travel support ECU 10 calculates the compensation steering control amount (compensation steering torque Trc) for correcting the basic steering control amount (target steering torque Tr*) as described above. The own vehicle 100 is traveling at a position deviating toward the right side with respect to the target travel line TL, and thus the compensation steering torque Trc is a positive value. The travel support ECU 10 obtains the value (=Tr*+Trc) by adding the compensation steering torque Trc to the target steering torque Tr* as the final steering control amount, and controls the steering motor 42 so that the actual steering torque Tra matches the final steering control amount (=Tr*+Trc) (that is, executes the correction control in addition to the lane trace control).

The travel support ECU 10 continues to calculate the lateral deviation dh each time the predetermined period elapses after the start of the correction control. The travel support ECU 10 determines whether or not the magnitude |dh| of the lateral deviation dh has fallen below the second threshold value Th2. When the magnitude |dh| of the lateral deviation dh has fallen below the second threshold value Th2, the travel support ECU 10 finishes the correction control.

In the example illustrated in FIG. 6 and FIG. 7, the elapsed period since the time point (time point t3) at which the correction control was started becomes equal to or longer than the second period threshold value Tm2 at a time point t4 without the magnitude |dh| of the lateral deviation dh falling below the second threshold value Th2. As a result, the finish condition is satisfied. The travel support ECU 10 finishes the lane trace control at the time point t4, and switches steering of the vehicle 100 to steering by the manual operation of the driver. Thus, as shown in FIG. 7, the basic steering control amount (target steering torque Tr*) rapidly decreases to zero immediately after the time point t4. As a result, the driver starts the operation of the steering wheel SW.

Meanwhile, the travel support ECU 10 stops the correction control based on the compensation steering torque Trc after the lane trace control is finished (after the time point t4), and executes the compensation control based on the compensation steering torque Trc′. At this time, the travel support ECU 10 multiplies the compensation steering torque Trc at the time point at which the lane trace control is finished by the gain Krc (0<Krc<1) to thereby obtain the compensation steering torque Trc′ for the compensation control after the lane trace control is finished. In this example, the compensation steering torque Trc′ is a value smaller by Dr (=(1−Krc)·Tend) than the compensation steering torque Trc (=Tend) at the time point at which the lane trace control is finished. The travel support ECU 10 controls the steering motor 42 (that is, executes the compensation control) so that the actual steering torque Tra matches the final steering control amount (=Trc′).

In this example, after the lane trace control is finished (after the time point t4), the travel support ECU 10 obtains the compensation steering torque Trc′ for the compensation control based on the compensation steering torque Trc calculated based on the correction control. Thus, the compensation control can be executed by changing the value of the compensation steering torque Trc through use of the control gain Krc while continuing calculation of the compensation steering torque Trc based on the correction control after the lane trace control is finished.

In the example of FIG. 6, it is assumed that a “curvature of the left curve 610 before the start of the lane trace control” and a “curvature of the left curve 610 at the time point at which the lane trace control is finished” are approximately the same as each other. In this case, when the steering of the own vehicle 100 is switched from the steering by the lane trace control to the steering by the manual operation, the driver tries to operate the steering wheel SW by a steering amount approximately the same as the steering amount before the start of the lane trace control (namely, the steering amount from the time point t0 to the time point t1) in consideration of the travel state (the curvature of the left curve 610) of the own vehicle. However, as described above, the compensation steering torque Trc′ after the lane trace control is finished is smaller by Dr than the compensation steering torque Trc (=Tend) at the time point at which the lane trace control is finished. Thus, in order to maintain the position of the own vehicle 100 within the left curve 610, the driver is required to apply, to the steering wheel SW, a steering amount larger than the steering amount before the start of the lane trace control (namely, the steering amount from the time point t0 to the time point t1) by at least Dr. Thus, the driver feels a sense of discomfort, and can thus recognize occurrence of an abnormality in the own vehicle 100. Meanwhile, the apparatus of this embodiment is configured to apply the compensation steering torque Trc′ to the steering mechanism even after the lane trace control is finished, and hence an operation bad imposed on the driver (a bad required for the steering) can be reduced by an amount corresponding to the compensation steering torque Trc′

Even when the “curvature of the left curve 610 before the lane trace control is started” and the “curvature of the left curve 610 at a certain specific time point after the lane trace control is finished” are different from each other, a similar effect as that described above is provided. That is, when the lane trace control is finished, the driver tries to operate the steering wheel SW by a “steering amount based on experience” on the basis of the travel state (the curvature of the left curve 610, the vehicle speed SPD, and the like) at that time. However, the compensation steering torque Trc′ is a value smaller by Dr (=(1−Krc)·Tend) than the compensation steering torque Trc (=Tend) at the time point at which the lane trace control is finished, and thus the driver is required to operate the steering wheel SW by a steering amount larger than the steering amount based on the experience. As a result, the driver feels a sense of discomfort. In this manner, the apparatus of this embodiment can enable the driver to recognize occurrence of an abnormality in the own vehicle.

Then, at a time point t6, the elapsed period since the time point (time point t4) at which the lane trace control was finished becomes equal to or longer than a predetermined third period threshold value Tm3. In this case, the travel support ECU 100 finishes the compensation control.

The apparatus of this embodiment determines the compensation steering torque Trc based on the lookup table MapTrc (dh, SPD) in the same manner as that during the execution of the lane trace control each time a predetermined period elapses in the period from the time point t4 to the time point t6, and obtains the compensation steering torque Trc′ by multiplying the determined compensation steering torque Trc by the control gain Krc (0<Krc<1).

<Operation>

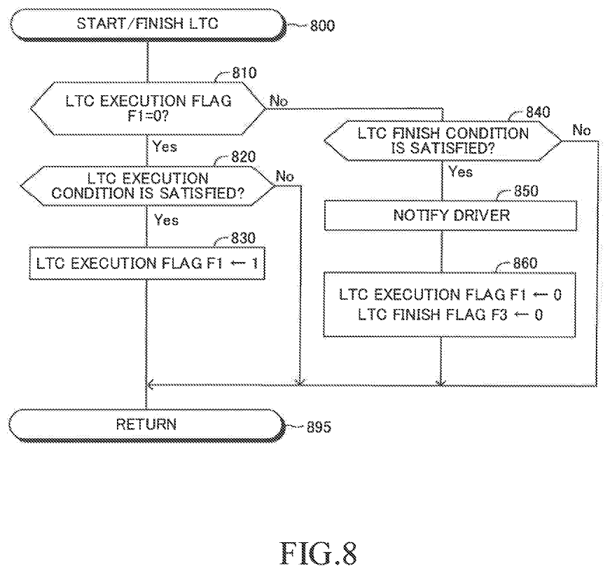

A description is now given of an operation of the CPU of the travel support ECU 10 (hereinafter sometimes simply referred to as “CPU”). The CPU is configured to execute the adaptive cruise control (ACC) through execution of a routine (not shown). The CPU is configured to execute an “LTC start/finish determination routine” illustrated in FIG. 8 when executing the adaptive cruise control.

Thus, the CPU starts the routine of FIG. 8 from Step 800 at a predetermined timing, and proceeds to Step 810 to determine whether or not a value of an LTC execution flag F1 is “0”. When the value of the LTC execution flag F1 is “1” this indicates a state in which the lane trace control is being executed. When the value of the LTC execution flag F1 is “0”, this indicates a state in which the lane trace control is not being executed. The value of the LTC execution flag F1 is set to “0” in an initialization routine to be executed by the CPU when an ignition switch (not shown) is changed from an OFF position to an ON position. Further, the value of the LTC execution flag F1 is set to “0” also in Step 860 described later.

When it is assumed that the lane trace control is currently not being executed, the value of the LTC execution flag F1 is “0”. In this case, the CPU makes a determination of “Yes” in Step 810, and proceeds to Step 820 to determine whether or not a predetermined execution condition is satisfied. This execution condition is also referred to as “LTC execution condition”.

The LTC execution condition is satisfied when all the following conditions 1 to 3 are satisfied.

(Condition 1): The adaptive cruise control is being executed, and the execution of the lane trace control is selected through the operation on the operation switch 17.

(Condition 2): The current state is a state in which at least the left white line and the right white line in the vicinity of the own vehicle can be recognized by the camera sensor 16b, and thus a highly reliable target travel line TL can be determined.

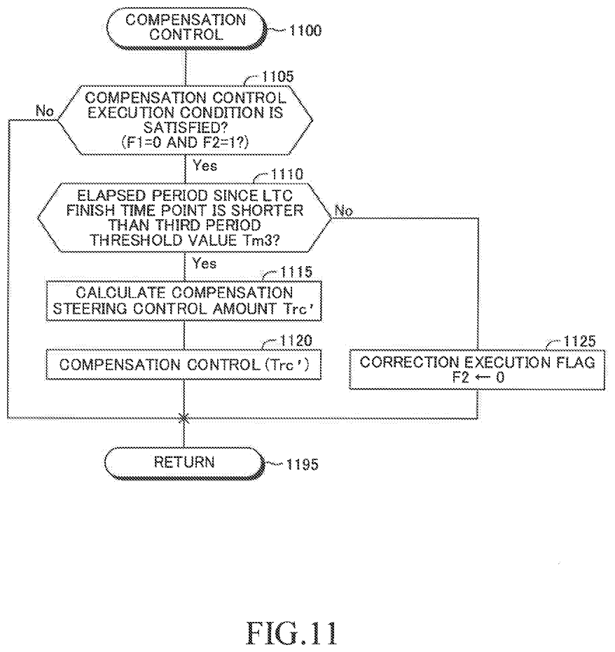

(Condition 3): A value of a correction execution flag F2 is “0”. When the value of the correction execution flag F2 is “1”, this indicates a state in which the correction control is being executed. When the value of the correction execution flag F2 is “0”, this indicates a state in which the correction control is not being executed. The value of the correction execution flag F2 is set to “0” in the above-mentioned initialization routine. Further, the value of the correction execution flag F2 is set to “0” also in Step 1125 of FIG. 11 described later.

The condition 2 may be the following condition:

The current state is a state in which at least the left white line and the right white line in the vicinity of the own vehicle can be recognized by the camera sensor 16b, or a steering-following preceding vehicle (ACC following target vehicle) exists, and thus the highly reliable target travel line TL can be determined.

When the LTC execution condition is not satisfied, the CPU makes a determination of “No” in Step 820, and directly proceeds to Step 895 to temporarily finish this routine.

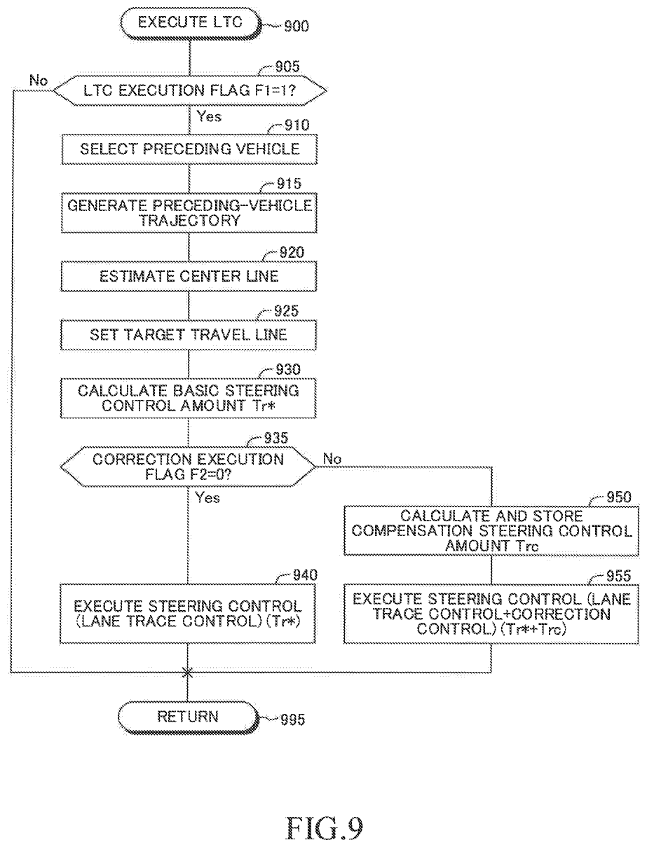

In contrast, when the LTC execution condition is satisfied, the CPU makes a determination of “Yes” in Step 820, and proceeds to Step 830 to set the LTC execution flag F1 to “1”. Then, the CPU proceeds to Step 895 to temporarily finish this routine. As a result, the lane trace control is started (see a determination of “Yes” in Step 905 of a routine of FIG. 9).

When the CPU starts the routine of FIG. 8 again from Step 800 after the lane trace control is started as described above, the CPU makes a determination of “No” in Step 810, and proceeds to Step 840. In Step 840, the CPU determines whether or not a predetermined finish condition is satisfied. This finish condition is also referred to as “LTC finish condition”.

The LTC finish condition is satisfied when at least one of the following conditions 4 to 6 are satisfied.

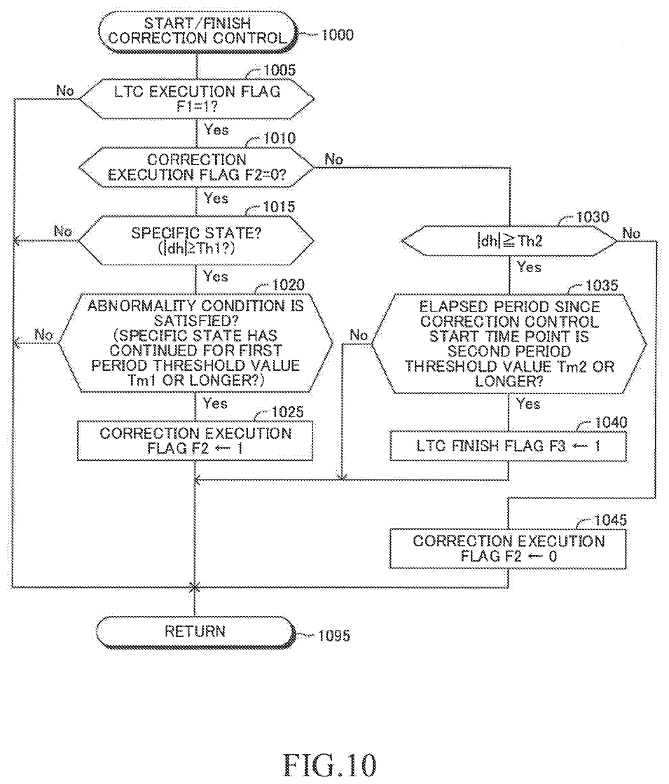

(Condition 4): A value of an LTC finish flag F3 is “1”. The value of the LTC finish flag F3 is set to “1” when the own vehicle is in the abnormal state, and thus the lane trace control is required to be finished. Specifically, the value of the LTC finish flag F3 is set to “1” in Step 1040 of a routine of FIG. 10 described later. The value of the LTC finish flag F3 is set to “0” in the above-mentioned initialization routine and Step 860 described later.

(Condition 5): The finish of the execution of the lane trace control is selected by the operation on the operation switch 17.

(Condition 6): The current state is a state in which none of the left white line and the right white line can be recognized by the camera sensor 16b, and thus a highly reliable target travel line TL cannot be determined. That is, the information required for the lane trace control cannot be acquired.

The condition 6 may be the following condition:

The current state is a state in which a steering-following preceding vehicle does not exist ahead of the own vehicle and none of the left white line and the right white line can be recognized by the camera sensor 16b, and as a result, a highly reliable target travel line TL cannot be determined.

When the LTC finish condition is not satisfied, the CPU makes a determination of “No” in Step 840, and directly proceeds to Step 895 to temporarily finish this routine.

In contrast, when the LTC finish condition is satisfied, the CPU makes a determination of “Yes” in Step 840, and sequentially executes the processing of Step 850 and Step 860 described below. Then, the CPU proceeds to Step 895 to temporarily finish this routine,

Step 850: The CPU displays on the display 52 a notification that the lane trace control is to be finished. As a result, the CPU notifies the driver of the finish of the lane trace control.

Step 860: The CPU sets the values of both of the LTC execution flag F1 and the LTC finish flag F3 to “0”.

Further, the CPU is configured to execute an “LTC execution routine” illustrated in FIG. 9 as a flowchart each time a predetermined period elapses. Thus, the CPU starts processing from Step 900 of FIG. 9 at a predetermined timing, and proceeds to Step 905 to determine whether or not the value of the LTC execution flag F1 is “1”.

When the value of the LTC execution flag F1 is not “1”, the CPU makes a determination of “No” in Step 905, and directly proceeds to Step 995 to temporarily finish this routine.

In contrast, when the value of the LTC execution flag F1 is “1”, the CPU makes a determination of “Yes” in Step 905, sequentially executes the processing of Steps 910 to 930 described below, and then proceeds to Step 935.

Step 910: The CPU selects a preceding vehicle for which the preceding-vehicle trajectory L1 is to be generated. Specifically, the CPU stores, in advance, object information associated with each object in the RAM based on the object information from the ambient sensor 16. The CPU selects an object closest to the travel direction of the own vehicle as a “preceding vehicle for which the preceding-vehicle trajectory L1 is to be generated” from that object information.

Step 915: The CPU generates the preceding-vehicle trajectory L1 of the preceding vehicle selected in Step 901 as described above.

Step 920: The CPU recognizes the “left white line LL and right white line RL” based on the information (lane information) from the ambient sensor 16. The CPU estimates a line connecting the center positions between the left white line LL and the right white line RL to one another, and determines the estimated line as the “center line LM”

Step 925: The CPU sets, as the target travel line TL, a corrected preceding-vehicle trajectory L2 generated based on both of the center line LM of the travel lane and the preceding-vehicle trajectory L1, as illustrated in FIG. 4.

Step 930: The CPU calculates the basic steering control amount (namely, the target steering torque Tr*) as described above.

The CPU proceeds to Step 935, and determines whether or not the value of the correction execution flag F2 is “0”. When the value of the correction execution flag F2 is “0”, the CPU makes a determination of “Yes” in Step 935, and proceeds to Step 940. In Step 940, the CPU executes the steering control (lane trace control) based on the basic steering control amount (target steering torque Tr*) as described above. Specifically, the CPU uses the steering ECU 40 to control the steering motor 42 so that the actual steering torque Ira matches the steering control amount (=Tr*). Then, the CPU proceeds to Step 995 to temporarily finish this routine.

In contrast, when the value of the correction execution flag F2 is not “0” (that is, when the value is “1”) the CPU makes a determination of “No” in Step 935, and sequentially executes the processing of Step 950 and Step 955. Then, the CPU proceeds to Step 995 to temporarily finish this routine.

Step 950: The CPU calculates the compensation steering control amount (compensation steering torque Trc) as described above.

Step 955: The CPU adds the compensation steering control amount (compensation steering torque Trc) to the basic steering control amount (target steering torque Tr*) to thereby obtain the value (=Tr*+Trc) as the final steering control amount. Then, the CPU executes the steering control (the lane trace control and the correction control) based on the final steering control amount. Specifically, the CPU uses the steering ECU 40 to control the steering motor 42 so that the actual steering torque Ira matches the final steering control amount (=Tr*+Trc).

Further, the CPU is configured to execute a “correction control start/finish determination routine” illustrated in FIG. 10 as a flowchart each time a predetermined period elapses. Thus, the CPU starts processing from Step 1000 of FIG. 10 at a predetermined timing, and proceeds to Step 1005 to determine whether or not the value of the LTC execution flag F1 is “1”.

When the value of the LTC execution flag F1 is not “1”, the CPU makes a determination of “No” in Step 1005, and directly proceeds to Step 1095 to temporarily finish this routine.

In contrast, when the value of the LTC execution flag F1 is “1”, the CPU makes a determination of “Yes” in Step 1005, and proceeds to Step 1010 to determine whether or not the value of the correction execution flag F2 is “0”.

When it is assumed that the correction execution flag F2 is currently “0”, the CPU makes a determination of “Yes” in Step 1010, and proceeds to Step 1015 to determine whether or not the specific state has occurred. Specifically, the CPU determines whether or not the magnitude |dh| of the lateral deviation dh is equal to or larger than the first threshold value Th1.

When the magnitude |dh| of the lateral deviation dh is not equal to or larger than the first threshold value Th1, the CPU makes a determination of “No” in Step 1015, and directly proceeds to Step 1095 to temporarily finish this routine.

In contrast, when the magnitude |dh| of the lateral deviation dh is equal to or larger than the first threshold value Th1, the CPU makes a determination of “Yes” in Step 1015, and proceeds to Step 1020 to determine whether or not the predetermined abnormality condition is satisfied. Specifically, the CPU determines whether or not the specific state has continued for the first period threshold value Tm1 or longer.

When the specific state has not continued for the predetermined first period threshold value Tm1 or longer, the CPU makes a determination of “No” in Step 1020, and directly proceeds to Step 1095 to temporarily finish this routine.

In contrast, when the specific state has continued for the predetermined first period threshold value Tm1 or longer, the CPU makes a determination of “Yes” in Step 1020, and determines that the own vehicle is in the abnormal state. Then, the CPU proceeds to Step 1025, and sets the correction execution flag F2 to “1”. After that, the CPU proceeds to Step 1095 to temporarily finish this routine. As a result, the CPU makes a determination of “No” in Step 935 of the routine of FIG. 9, and proceeds to Step 950 and Step 955. Thus, the correction control is started during the execution of the steering control (lane trace control).

After the CPU sets the correction execution flag F2 to “1”, when the CPU starts the routine of FIG. 10 again, the CPU makes a determination of “Yes” in Step 1005, makes a determination of “No” in Step 1010, and proceeds to Step 1030. In Step 1030, the CPU determines whether or not the magnitude |dh| of the lateral deviation dh is equal to or larger than the second threshold value Th2.

When the magnitude |dh| of the lateral deviation dh is equal to or larger than the second threshold value Th2, the CPU makes a determination of “Yes” in Step 1030, and proceeds to Step 1035 to determine whether or not a period (an elapsed period since the start time point of the correction control) in which the correction control has continuously been executed since the time point at which the correction control was started (that is, the time point at which the correction execution flag F2 was set to “1”) has become equal to or longer than the second period threshold value Tm2.

When the elapsed period since the start time point of the correction control is not equal to or longer than the second period threshold value Tm2, the CPU makes a determination of “No” in Step 1035, and directly proceeds to Step 1095 to temporarily finish this routine. Thus, the correction control is continued.

In contrast, when the elapsed period since the start time point of the correction control has become equal to or longer than the second period threshold value Tm2, the CPU makes a determination of “Yes” in Step 1035, and proceeds to Step 1040 to set the LTC finish flag F3 to “1”. Then, the CPU proceeds to Step 1095 to temporarily finish this routine. As a result, when the CPU proceeds to Step 840 of FIG. 8, the condition 4 of the LTC finish condition is satisfied. Thus, the CPU makes a determination of “Yes” in Step 840, and proceeds to Step 860. As a result, the value of the LTC execution flag F1 is set to “0”. In the routine of FIG. 9, the CPU makes a determination of “No” in Step 905, and directly proceeds to Step 995. Thus, the lane trace control is finished.

At the time point at which the CPU proceeds to Step 1030, when the magnitude |dh| of the lateral deviation dh is not equal to or larger than the second threshold value Th2, the CPU makes a determination of “No” in Step 1030, and proceeds to Step 1045 to set the correction execution flag F2 to “0”. After that, the CPU proceeds to Step 1095 to temporarily finish this routine. Thus, the CPU makes a determination of “Yes” in Step 935 of the routine of FIG. 9. As a result, the CPU finishes the correction control

Further, the CPU is configured to execute a “compensation control execution routine” illustrated in FIG. 11 as a flowchart each time a predetermined period elapses. Thus, the CPU starts processing from Step 1100 of FIG. 11 at a predetermined timing, and proceeds to Step 1105 to determine whether or not a predetermined compensation control execution condition is satisfied,

The compensation control execution condition is a condition for determining whether or not the lane trace control has been finished under the state in which the correction control is being executed for the lane trace control. Specifically, the compensation control execution condition is satisfied when the value of the LTC execution flag F1 is “0”, and the value of the correction execution flag F2 is “1”.

When the compensation control execution condition is not satisfied, the CPU makes a determination of “No” in Step 1105, and directly proceeds to Step 1195 to temporarily finish this routine.

In contrast, when the compensation control execution condition is satisfied, the CPU makes a determination of “Yes” in Step 1105, and proceeds to Step 1110 to determine whether or not the elapsed period since the time point at which the lane trace control was finished is shorter than the third period threshold value Tm3.

It is assumed that the lane trace control has been finished immediately before the current time. Thus, the elapsed period since the time point at which the lane trace control was finished is shorter than the third period threshold value Tm3. Thus, the CPU makes a determination of “Yes” in Step 1110, and sequentially executes the processing of Step 1115 and Step 1120 described below. Then, the CPU proceeds to Step 1195 to temporarily finish this routine.

Step 1115: The CPU calculates a compensation steering control amount (hereinafter simply referred to as “post-LTC compensation steering torque Trc′”) in the compensation control after the lane trace control is finished. Specifically, the CPU calculates the compensation steering control amount (compensation steering torque Trc) by applying the actual lateral deviation dh and the actual vehicle speed SPD to the lookup table MapTrc (dh, SPD) as described above. Then, the CPU calculates the post-LTC compensation steering torque Trc′ (=Krc·Trc) by multiplying the compensation steering torque Trc by the “control gain Krc larger than 0 and smaller than 1”.

Step 1120: The CPU executes the compensation control based on the compensation steering control amount (post-LTC compensation steering torque Trc′) obtained in Step 1115. That is, the CPU controls the steering motor 42 so that the actual steering torque Tre matches the final steering control amount (=compensation steering torque Trc′).

The elapsed period since the time point at which the lane trace control was finished becomes equal to or longer than the third period threshold value Tm3 while the CPU is repeating the execution of Steps 1110 to 1120 as described above. When the CPU proceeds to Step 1110 under this state, the CPU makes a determination of “No” in Step 1110, and proceeds to Step 1125. In Step 1125, the CPU sets the correction execution flag F2 to “0”. After that, the CPU proceeds to Step 1195 to temporarily finish this routine. As a result, when the CPU starts the routine of FIG. 11 again, the CPU makes a determination of “No” in Step 1105. That is, the compensation control after the lane trace control was finished is finished.

<Effects of Apparatus of this Embodiment>

As described above, the apparatus of this embodiment starts the correction control when determining that an abnormal state has occurred during the execution of the lane trace control. Further, when the lane trace control is finished under the state in which the correction control is being executed (that is, when the finish condition is determined to be satisfied), the apparatus of this embodiment executes the compensation control after the lane trace control is finished. The apparatus of this embodiment applies the compensation steering torque Trc′ to the steering mechanism even after the lane trace control is finished, and thus the operation load imposed on the driver (the load required for the steering) can be reduced by the amount corresponding to the compensation steering torque Trc′.

Further, the apparatus of this embodiment changes the post-LTC compensation steering torque Tre so that the post-LTC compensation steering torque Trc′ has the same sign as that of the compensation steering torque Trc determined on the assumption that the correction control is continued after the lane trace control is finished, and has a value whose magnitude is smaller than that of the compensation steering torque Trc. At a certain specific time point after the lane trace control is finished, the driver tries to operate the steering wheel SW by the “steering amount based on experience” on the basis of the travel state (the curvature of the left curve 610, the vehicle speed SPD, and the like) at that specific time point. However, the magnitude of the post-LTC compensation steering torque Trc′ is smaller than that of the compensation steering torque Trc determined on the assumption that the correction control is executed at the specific time point. Thus, the driver is required to operate the steering wheel SW by a steering amount larger than the “steering amount based on experience”. As a result, the driver feels a sense of discomfort. In such a manner, the apparatus of this embodiment can enable the driver to recognize occurrence of an abnormality in the own vehicle.

The present disclosure is not limited to the embodiment described above, and various modification examples can be adopted within the scope of the present disclosure.

The method of calculating the post-LTC compensation steering torque Trc′ is not limited to the above-mentioned example. For example, the travel support ECU 10 may obtain the post-LTC compensation steering torque Trc′ through use of an upper limit value to limit the compensation steering torque. More specifically, the travel support ECU 10 stores, as an upper limit value Tup, a value obtained by multiplying the compensation steering torque Trc (=Tend) at the time point at which the lane trace control is finished (or a time point immediately before the finish time point) by a “coefficient Kh larger than 0 and smaller than 1”. The travel support ECU 10 obtains the compensation steering torque Trc by applying the actual lateral deviation dh and the actual vehicle speed SPD to the lookup table MapTrc (dh, SPD) after the time point at which the lane trace control is finished. Then, when the magnitude of the compensation steering torque Trc is larger than the magnitude of the upper limit value Tup, the travel support ECU 10 obtains a “value having the same sign as that of the compensation steering torque Trc and having the same magnitude as that of the upper limit value Tup” as the post-LTC compensation steering torque Trc′. When the magnitude of the compensation steering torque Trc is equal to or smaller than the magnitude of the upper limit value Tup, the travel support ECU 10 obtains the compensation steering torque Trc as the post-LTC compensation steering torque Trc′. In still another example, the travel support ECU 10 uses a value obtained by multiplying the compensation steering torque Trc (=Tend) at the time point at which the lane trace control is finished by a correction coefficient kh as an initial value of the post-LTC compensation steering torque Trc′ immediately after the time point at which the lane trace control is finished. Further, the travel support ECU 10 may employ a value that decreases from that initial value as the time elapses as the post-LTC compensation steering torque Trc′.

The “specific state” is not limited to the above-mentioned example. For example, the specific state may be a state in which a difference between the steering control amount (target steering torque Tr′) in a driver model and the current steering control amount (target steering torque Tr*) is equal to or larger than a predetermined threshold value. The “driver model” is a standard steering control amount predetermined for a combination of a road shape (e.g., a curvature of a target travel lane) and the vehicle speed SPD. The driver model may be statistically modeled from information on driving operations of many drivers. That driver model can be stored in the ROM 10x in a form of a lockup table. In such a configuration, the travel support ECU 10 may calculate a difference “d” between the steering control amount (target steering torque Tr′) in the driver model and the current steering control amount (target steering torque Tr*) as the compensation steering control amount (compensation steering torque Trc) in the correction control. The travel support ECU 10 may further calculate a value obtained by multiplying the difference “d” by a “coefficient kj larger than 0 and smaller than 1” as the compensation steering control amount (compensation steering torque Trc). Further, in this case, the travel support ECU 10 may calculate the difference also even the lane trace control is finished, and obtain a value calculated by multiplying the difference by the control gain Krc as the post-LTC compensation steering torque Trc′.

Further, the “specific state” may be a state in which such an abnormality that the own vehicle 100 is likely to deviate toward the right side or the left side with respect to the target travel line TL is detected. For example, the “specific state” may be a state in which an abnormality in a steering system (e.g., the steering mechanism), an abnormality in the ambient sensor 16, an abnormality in a braking driving force control system, and the like are detected.

The apparatus of this embodiment may also be applied to a case in which lane trace control of using only one of the center line LM and the preceding-vehicle trajectory L1 as the target travel line TL is executed.

In the apparatus of this embodiment, the lane trace control is executed only while the adaptive cruise control is being executed, but the lane trace control may be executed even while the adaptive cruise control is not being executed.

Further, the travel support ECU 10 may be configured to execute the lane trace control (LTC) as the normal travel support control, and execute braking/driving force distribution control of adjusting magnitudes of braking/driving forces in each of the left and right wheels of the vehicle as the correction control and the compensation control. For example, one of the following mechanisms (a) to (c) may be employed as a braking/driving force distribution mechanism: (a) a differential mechanism configured to control a distribution ratio of a driving force transmitted from an internal combustion engine or an electric motor between the left and right wheels, (b) a mechanism configured to control a distribution ratio of a braking force between the left and right wheels, and (c) a mechanism configured to use in-wheel motors so that braking/driving forces of the left and right wheels can be controlled independently of each other. More specifically, as an actuator configured to execute the braking/driving force distribution control, a brake actuator (an actuator configured to distribute the braking force to the left and right wheels) and/or the in-wheel motors (actuators configured to distribute the driving force to the left and right wheels) may be used.

In the above-mentioned configuration, the travel support ECU 10 is configured to use the control amount (target steering torque Tr*) corresponding to the steering torque of the vehicle as the turn control amount in the lane trace control (LTC). Further, the travel support ECU 10 is configured to use a yaw moment additional amount as the compensation control amount in the correction control. When the travel support ECU 10 determines that the own vehicle is in the abnormal state during the execution of the lane trace control, the travel support ECU 10 executes the correction control (braking/driving force distribution control) in addition to the lane trace control (LTC). The travel support ECU 10 calculates a yaw moment additional amount Mrc through application of the actual lateral deviation dh and the actual vehicle speed SPD to a lookup table MapMrc (dh, SPD) defining a relationship among the lateral deviation dh, the vehicle speed SPD, and the yaw moment additional amount Mrc. The travel support ECU 10 executes the correction control by controlling the brake actuator and/or the in-wheel motors based on the yaw moment additional amount Mrc. Further, the travel support ECU 10 is configured to use the yaw moment additional amount as the compensation control amount in the compensation control. The travel support ECU 10 stops the lane trace control and the correction control when a predetermined finish condition (e.g., LTC finish condition) is satisfied. Then, the travel support ECU 10 uses the lookup table MapMrc (dh, SPD) to calculate the yaw moment additional amount Mrc after the time point at which the lane trace control is finished. Further, the travel support ECU 10 calculates a yaw moment additional amount Mrc′ (=Krd·Mrc) after the finish of the LTC by multiplying the yaw moment additional amount Mrc by a “control gain Krd larger than 0 and smaller than 1”. The travel support ECU 10 executes the compensation control by controlling the brake actuator and/or the in-wheel motors based on the yaw moment additional amount Mrc′. The above-mentioned yaw moment additional amount Mrc corresponds to an example of the “first value of the compensation control amount”. The yaw moment additional amount Mrc′ corresponds to an example of the “second value of the compensation control amount”.

Further, the travel support ECU 10 may be configured to execute the braking/driving force distribution control, to thereby execute the lane trace control (travel support control), the correction control, and the compensation control.

For example, the travel support ECU 10 executes the braking/driving force distribution control in accordance with the travel state of the vehicle, to thereby execute the lane trace control (travel support control). For example, the travel support ECU 10 calculates a basic target yaw rate Yra through application of the actual vehicle speed SPD and the actual curvature CL to a lookup table MapYrc (SPD, CL) defining a relationship among the vehicle speed SPO, the curvature CL of the road, and the basic target yaw rate Yra. The travel support ECU 10 executes the lane trace control (travel support control) by controlling the brake actuator and/or the in-wheel motors based on the basic target yaw rate Yra. When the travel support ECU 10 determines that the own vehicle is in the abnormal state during the execution of the lane trace control (travel support control), the travel support ECU 10 executes the correction control. The travel support ECU 10 calculates an additional target yaw rate Yrb through application of the actual lateral deviation dh and the actual vehicle speed SPD to a lookup table MapYrd (dh, SPD) defining a relationship among the lateral deviation dh, the vehicle speed SPD, and the additional target yaw rate Yrb. The travel support ECU 10 obtains a value (=Yra+Yrb) calculated by adding the compensation control amount (additional target yaw rate Yrb) to the basic control amount (basic target yaw rate Yra) as a final control amount. The travel support ECU 10 executes the correction control in addition to the lane trace control (travel support control) by controlling the brake actuator and/or the in-wheel motors based on the final control amount. The travel support ECU 10 stops the lane trace control (travel support control) and the correction control when a predetermined finish condition (e.g., LTC finish condition) is satisfied. Then, the travel support ECU 10 uses the lookup table MapYrd to calculate the additional target yaw rate Yrb after the time point at which the lane trace control is finished. The travel support ECU 10 calculates an additional target yaw rate Yrb′ (=Kre·Yrb) after the finish of the lane trace control (travel support control) by multiplying the additional target yaw rate Yrb by a “control gain Kre larger than 0 and smaller than 1”. The travel support ECU 10 executes the compensation control by controlling the brake actuator and/or the in-wheel motors based on the additional target yaw rate Yrb′. The above-mentioned “basic target yaw rate Yra” corresponds to an example of the “turn control amount”. The above-mentioned additional target yaw rate Yrb corresponds to an example of the “first value of the compensation control amount”. The above-mentioned additional target yaw rate Yrb′ corresponds to an example of the “second value of the compensation control amount”.

What is claimed is:

1. A vehicle travel support apparatus, comprising:
a normal control module configured to execute travel support control of changing a turn control amount, which enables a travel direction of a vehicle to be changed, based on information on a road on which the vehicle is traveling so that the vehicle is to travel along the road;
a correction control module configured to:
determine whether a state of the vehicle is brought into an abnormal state, in which a possibility that the travel support control enables the vehicle to travel along the road is low, during the execution of the travel support control; and
execute, when determining that the state of the vehicle is brought into the abnormal state, in addition to the travel support control, correction control of changing a first value of a compensation control amount in accordance with a parameter indicating a travel state of the vehicle, the first value of the compensation control amount being a value which enables the travel direction of the vehicle to be changed and increases the possibility; and
a compensation control module configured to:
determine whether a predetermined finish condition is satisfied during the execution of the correction control; and
stop, when determining that the predetermined finish condition is satisfied, both the travel support control and the correction control and execute compensation control after a time point at which the predetermined finish condition is satisfied, the compensation control involving changing a second value of the compensation control amount in accordance with the parameter indicating the travel state of the vehicle, and the second value of the compensation control amount being a value which enables the travel direction of the vehicle to be changed and facilitates traveling of the vehicle along the road when a driver of the vehicle performs a steering operation so that the vehicle is to travel along the road,
wherein the compensation control module is configured to change the second value of the compensation control amount so that the second value has a value for generating, in the vehicle, a turn motion in the same direction as a direction of a turn motion generated in the vehicle by the first value of the compensation control amount determined by the correction control module on an assumption that the correction control is continued after the time point at which the predetermined finish condition is satisfied, and so that a magnitude of the second value is smaller than a magnitude of the first value.

2. The vehicle travel support apparatus according to claim 1,
wherein the normal control module is configured to use a control amount corresponding to a steering torque of the vehicle as the turn control amount,
wherein the correction control module is configured to use a control amount corresponding to a steering torque for correcting the turn control amount as the compensation control amount, and
wherein the compensation control module is configured to use a control amount corresponding to the steering torque of the vehicle as the compensation control amount.

3. The vehicle travel support apparatus according to claim 1,
wherein the normal control module is configured to determine a target travel line based on at least the information on the road, and change the turn control amount so that the vehicle is to travel along the target travel line, and
wherein the correction control module is configured to determine that the state of the vehicle is brought into the abnormal state when a state in which a magnitude of a distance between the vehicle and the target travel line is equal to or larger than a first threshold value has continued for a first period threshold value or longer.

4. The vehicle travel support apparatus according to claim 3, wherein the compensation control module is configured to determine that the predetermined finish condition is satisfied when a state in which the magnitude of the distance between the vehicle and the target travel line is not equal to or smaller than a second threshold value, which is smaller than the first threshold value, has continued since a start time point of the correction control for a second period threshold value or longer.

5. The vehicle travel support apparatus according to claim 3,
wherein the correction control module is configured to use the distance between the vehicle and the target travel line as the parameter indicating the travel state, and
wherein the compensation control module is configured to employ a product of the first value of the compensation control amount calculated by the correction control module and a positive gain smaller than 1, as the second value of the compensation control amount.
